(19) United States
(12) Patent Application Publication
(10) Pub. No.: US 2022/0379561 A1
(43) Pub. Date: Dec. 1, 2022

(54) OBJECT DECAKING

(71) Applicant: HEWLETT-PACKARD DEVELOPMENT COMPANY, L.P., Spring, TX (US)

(72) Inventors: Guillermo Moliner Clemente, Sant Cugat del Valles (ES); Eduard Galdeano Castillo, Sant Cugat del Valles (ES); Alejandro Torres Pinero, Sant Cugat del Valles (ES)

(21) Appl. No.: 17/755,122

(22) PCT Filed: Mar. 2, 2020
(86) PCT No.: PCT/US2020/020590

§ 371 Date: Apr. 21, 2022

(51) Int. Cl. B29C 64/35; B29C 64/153; B22F 10/20

(52) U.S. Cl. CPC B29C 64/35; B29C 64/153; B22F 10/20; B33Y 40/20

(57) ABSTRACT

The invention relates to a decake apparatus. The decake apparatus has a chamber with a base to support a build cake. The build cake includes a build object and non-solidified build material. The apparatus includes a distributor from which to force a fluidisation medium into a lower portion of a build cake supported on the base to fluidise non-solidified build material around the build object so that the build object sinks through the fluidised non-solidified build material towards the base. The also includes a material outlet through which non-solidified build material can be removed from the chamber.

Additive manufacturing systems can be used to manufacture three-dimensional (3D) objects. This can be achieved, for example, by forming successive layers of a build material on a build platform and selectively solidifying portions of those layers to build up a 3D object within a build cake. Objects such as product components can be built up in layers within the build cake in an additive manufacturing system in accordance with object descriptions as part of a build instruction that are interpreted and applied by a print controller.

In an example additive manufacturing process the object is separated from the build cake in a decaking operation in which the build cake is supported on a base and non-solidified build material of the build cake is removed.

Examples of the present disclosure will now be described with reference to the accompanying Figures, in which:

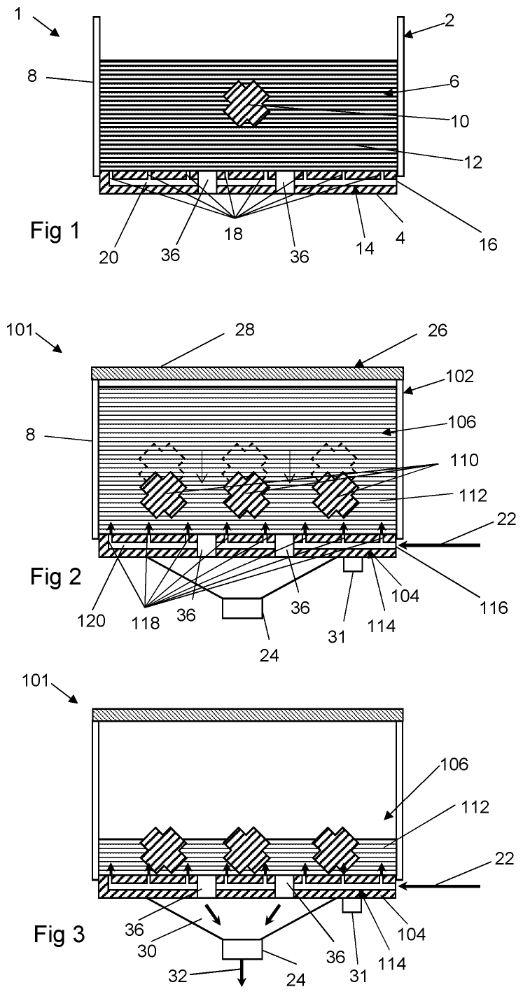

FIG. 1 shows a schematic view of an example of a decake apparatus in an initial state;

FIG. 2 shows a schematic view of a different example of a decake apparatus in a fluidised state;

FIG. 3 shows a schematic view of an example of a decake apparatus in a fluidised and non-solidified build material removal state;

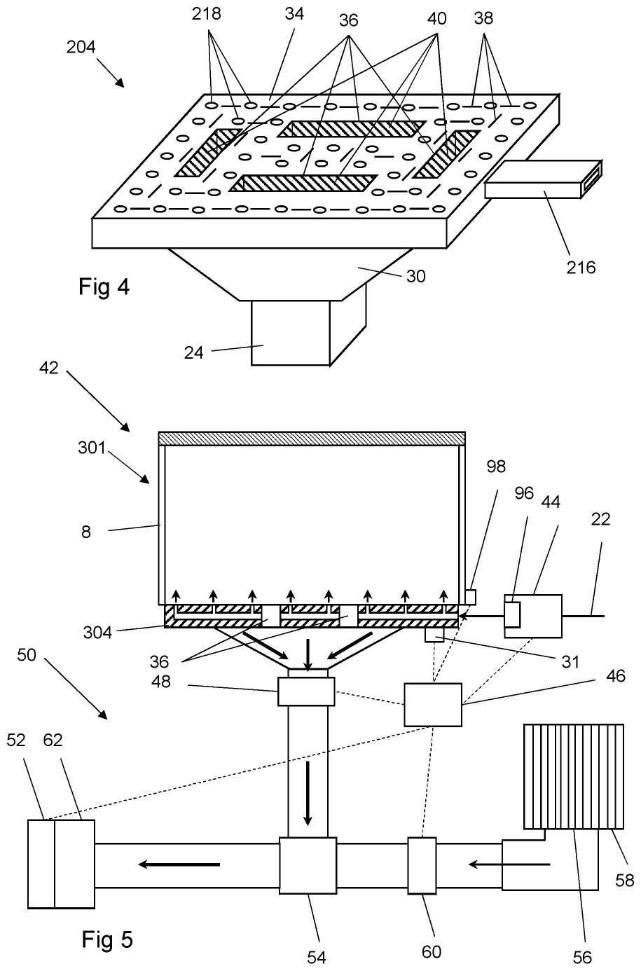

FIG. 4 shows a detailed schematic view of an example of a base of a decake apparatus;

FIG. 5 shows a schematic view of an example of a decake system;

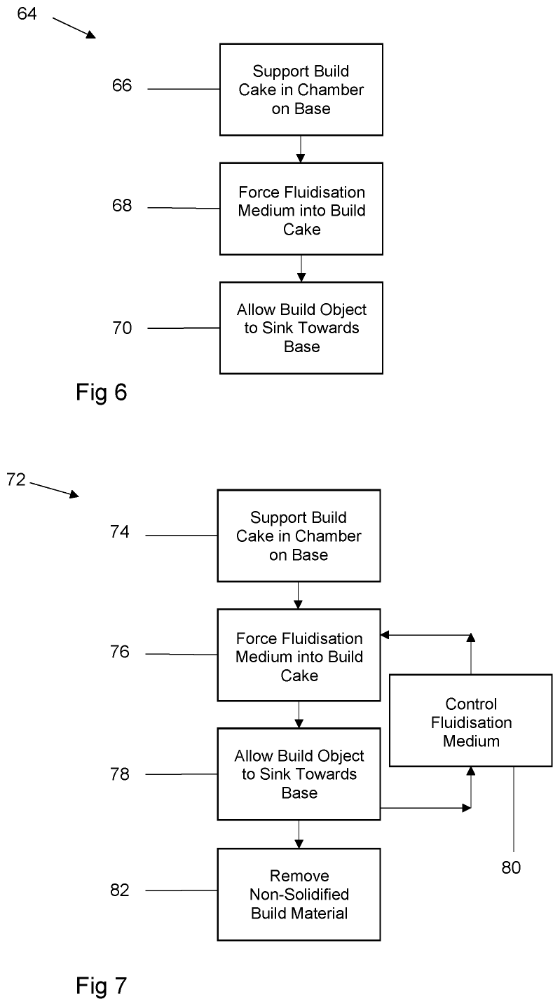

FIG. 6 shows a flow chart of an example method;

FIG. 7 shows a flow chart of another example method; and

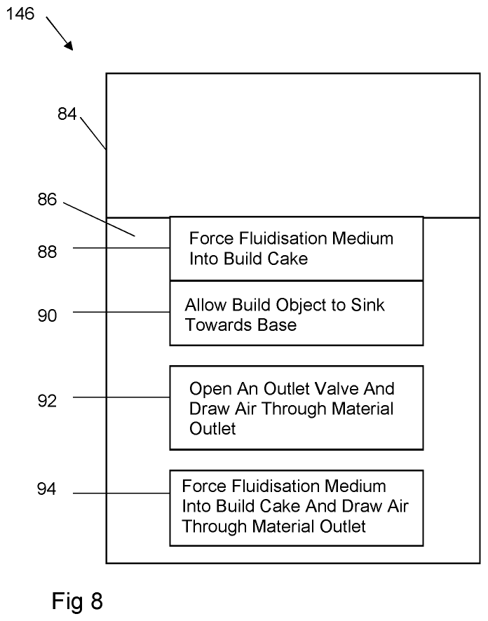

FIG. 8 shows an example of a schematic diagram of an example of a controller.

FIG. 1 schematic view of an example of a decake apparatus 1 in an initial state. The decake apparatus 1 comprises a chamber 2 defined by a base 4 and the peripheral wall 8. The base 4 supports a build cake 6. The build cake 6 comprises a build object 10 and non-solidified build material 12.

The apparatus 1 comprises a distributor 14 from which a fluidisation medium can be forced into a lower portion of the build cake 6. The fluidisation medium is forced into the build cake 6 to fluidise non-solidified build material 12 around the build object 10. In this example non-solidified build material 12 can be fluidised substantially throughout the chamber, but in other examples the fluidisation may be restricted to localised regions within the chamber.

The chamber 2 of this example is a chamber into which the build cake 6 is transferred after it has been created during an additive manufacturing process. In an example of a process, the build cake is ejected from the build chamber into in which it is created into the volume within the peripheral wall 8. The bottom of the peripheral wall 8 may be closed using a plate to allow the build cake 6 to be transferred onto the base 4. Once the build cake 6 is located above the base 4 the plate can be removed and the build cake 6 supported on the base 4. In other examples the build cake 6 is transferred from a build chamber to a decake apparatus using other methods.

In other examples the chamber 2 of the decake apparatus 1 may be the build chamber within which the build cake 6 is created during an additive manufacturing process.

The base 4 of this example comprises the distributor 14 which has an inlet 16 connected to a plurality of outlets 18. Fluidisation medium entering the distributor 14 through the inlet 16 passes through a flow channel 20 to the outlets 18. In this way fluidisation medium can be forced into the distributor 14 through the inlet 16 and into the bottom of the build cake 6 via the flow channel 20 and outlets 18. In other examples the distributor 14 may comprise a single outlet, for example formed as an elongate slot, or grid of slots to distribute the fluidisation medium across the base 4.

In this example the distributor 14 is located in the base. In other examples the distributor 14 may be located on the base. In further examples the distributor may be additionally, or alternatively, arranged in, or on, the peripheral wall 8.

In this example the base 4 includes material outlets 36 through which non-solidified build material can pass during a build material removal operation. In some examples the passage of non-solidified build material through the material outlets may be selectively prevented or hindered to control removal of non-solidified build material from the chamber. In some examples the passage of non-solidified build material through the material outlets may be actively prevented by opening or closing valves, shutters, or similar restrictors which may be located in the material outlets, or may be located in a material flow path downstream of the material outlets. In some examples the passage of non-solidified build material through the material outlets may be passively prevented by including openings into, or in, the material outlets across which the non-solidified build material forms bridges meaning that the non-solidified build material will not flow though the material outlet without additional energy being supplied, for example via a vibration.

In other examples material outlets may be additionally, or alternatively, provided in the peripheral walls, or on hoses which can be moved within the chamber 2.

In this example, the additive manufacturing system that is used in the build process to create the build cake uses build material which is spread over a build platform to form a build layer in a build chamber. Selected portions of the build layer may be solidified, for example by fusing, sintering, melting, binding or otherwise joining the build material using, for example, heat energy applied from an energy source and a fusing agent. The build platform is then lowered by a predetermined amount and a new build layer formed on the previously formed layer and the process repeated. In this way the build object is created within a build cake which is made up of the build object, or objects, and non-solidified build material.

The build material may comprise any suitable form of build material, for example fibres, granules or powders. The build material can include thermoplastic materials, ceramic material and metallic materials.

FIG. 2 shows a schematic view of a different example of a decake apparatus 101 in a fluidised state. The decake apparatus 101 is similar to the decake apparatus 1 of FIG. 1. Identical features will be referenced with the same numeral and like features will be referenced by the same numeral incremented by 100.

The build cake 106 is similar to that described above, but in this example it includes a plurality of build objects 110. The decake apparatus 101 includes a base 104 which comprises a build material removal channel 24 through which non-solidified build material passing through the material outlets 36 can be removed from the build cake 106. The decake apparatus 101 also comprises a lid 26 on the peripheral wall 8. The lid 26 closes the chamber 102 but allows the passage of fluidisation medium to leave the chamber 102. In this example the lid 26 comprises a filter element 28 though which fluidisation medium can pass, but through which build material cannot pass. In other examples the lid 26 comprises a fluidisation medium outlet channel.

As shown in FIG. 2 a fluidisation medium is indicated by the arrow 22 and is forced into the distributor 114 in the base 104 so that it passes though the flow channel 120 and out of the outlets 118. The flow of fluidisation medium, in this example compressed, dry, air, into the build cake 106 from the outlets 118 initially causes the build cake 106 to expand as the fluidisation medium passes into, and through, the non-solidified build material 112. As the flow of fluidisation medium increases, the non-solidified build material 112 becomes fluidised and so behaves as a fluid. The build objects 110 have a density greater than that of the fluidised non-solidified build material 112 and so sink through the fluidised non-solidified build material 112 towards the base 104. In other examples the fluidisation medium could be a different fluid, for example a different gas, which will not damage or adversely impact the build objects 110 or non-solidified build material. Some examples use compressed environmental air. Other examples use compressed nitrogen.

The fluidised non-solidified build material 112 flows around the build objects 110 as they sink towards the base 104 and this may assist with the removal of non-solidified build material 112 from a surface of the build objects 110. The lid 26 prevents the loss of non-solidified build material 112 from the top of the chamber 106. In some examples the fluidisation of the non-solidified build material 112 is assisted by a vibration of a part of the chamber 102, for example the base 104 and/or the peripheral wall 8.

Causing, or allowing, the build objects 110 to sink towards the base 104 through fluidised non-solidified build material 112 provides control over the rate at which the build objects 110 move towards the base 104 and reduces the distance between the build objects 110 and the base 104. This control over the movement may reduce the risk of damage to the build objects 110 during a subsequent operation, such as the removal of non-solidified build material 112 from around the build objects 110.

Removal of the non-solidified build material 112 from below the build object 110 may cause the object to fall towards the base 104 in an uncontrolled manner. Uncontrolled, or rapid, contact between the base and the build objects 110 may cause damage to the object build object 110. The uncontrolled falling or movement of the build objects 110 during removal of non-solidified build material 112 may also result in the build objects 110 hitting one another which may cause damage. Allowing the build objects to sink through fluidised build material in a controlled manner reduces the height from which an uncontrolled fall can occur and may reduce the rate at which the build objects can move and may therefore reduce the risk of damage during such an operation.

In some examples the process may be a two-step process in which a first step is to cause the build objects 110 to sink towards the base 104 through fluidised non-solidified build material 112 and, once the build objects have sunk towards the base, a second step is to remove non-solidified build material 112. In other examples the sinking of the build objects 110 and removal of non-solidified build material 112 may take place simultaneously. In such examples the rate of removal of non-solidified build material 112 may be controlled to ensure that the build objects sink in a controlled manner through the fluidised non-solidified build material before non-solidified build material is removed at a rate which may increase the likelihood of the build objects falling in an uncontrolled manner which may increase the risk of damage.

In this example the non-solidified build material 112 is continuously fluidised until the build objects 110 reach the base 104 and rest thereon. Once the build 110 objects rest upon the base a next operation is carried out which involves the removal of non-solidified build material 112 from the chamber 102.

In this example a sensor 31, for example a contact sensor or other suitable sensor, is provided to confirm that the build objects 110 have made contact with the base 104 at which time fluidisation can be ceased. In other examples the non-solidified build material 112 can be fluidised for a sinking time which is pre-determined to be sufficiently long to ensure that the build objects 110 sink through the fluidised non-solidified build material to reach the base 104. The rate at which the build objects 110 sink though the fluidised non-solidified build material 112 can be adjusted by altering the rate at which fluidisation medium is force into the non-solidified build material 112. A combination of a pre-determined fluidisation duration and a sensor 31 can also be used.

The time taken for the build objects 110 to reach the base 104 depends upon the initial position of the objects 110 within the build cake and the rate at which the build objects 110 sink through the fluidised non-solidified build material 112.

In some examples the fluidisation of the non-solidified build material 110 is not continuous. Periods of fluidisation are separated by periods during which no fluidisation occurs. In this way the build objects 110 sink towards the base in a series of steps which may limit the maximum rate at which they can sink and also limits the maximum distance of any sinking movement of the build objects.

In other examples the build objects 110 sink towards the base 104, but may not reach the base 104 before the removal of non-solidified build material 112 from the chamber 102 operation begins. The sinking of the build objects 110 towards the base 104 reduces the risk of damage to the build objects 110 as the build objects 110 have less far to fall in an uncontrolled manner before reaching the base 104 during a subsequent operation.

FIG. 3 shows a shows a schematic view of the example of a decake apparatus 101 in a second 112 state in which non-solidified build material is fluidised and non-solidified build material is removed from the chamber.

Fluidisation medium is being forced into the distributor 114 as shown by arrow 22 and non-solidified build material 112 is being removed from the build cake 106 via the material outlets 36 and build material removal channel 24 as indicated by arrow 32. In this example the fluidised non-solidified build material 112 passes through material outlets 36 in the base 104 into a collector 30 which directs it into the build material removal channel 24. This removal of non-solidified build material can be automated which may help to reduce a risk of exposure of a user to powder. This will be described in more detail with reference to FIG. 4.

In this example, once the build object sinking phase has been completed, fluidisation and non-solidified build material 112 removal occurs simultaneously during the material removal phase. The removal of the non-solidified build material 112 may, in some examples, be assisted by the suction of air though the build material removal channel 24.

In other examples the fluidisation and non-solidified build material 112 removal occur in a repeated sequence in which fluidisation of the non-solidified build material 112 redistributes non-solidified build material 112 across the base 104 prior to a material removal operation. Removal of non-solidified build material 112 through the material outlets 36 of the base 104 may cause local loss of non-solidified build material 112 in the vicinity of the material outlets 36. The sequence may include overlaps between the fluidisation and removal operations, or there may be no overlaps between the two operations. In some examples vibration of part of the chamber 102, for example the base 104 and/or the peripheral wall 8, may assist the fluidisation and/or the removal operation.

FIG. 4 shows a detailed schematic view of an example of a base 204 of a decake apparatus. The base 204 has an inlet 216 for the introduction of a fluidisation medium into a distributor within the base 204. The distributor channels fluidisation medium from the inlet 216 to a plurality of outlets 218 from an upper surface 34 of the base 204 on which a build cake can be supported. The distributor is designed so that fluidisation medium is emitted from each of the plurality of outlets 218 and that the flow from each is substantially equal. Other examples may have a distributor from which fluidisation medium is emitted at a greater flow rate from predetermined regions, for example a central region, as this may assist with controlling the sinking of the build objects, for example so that they do not contact the peripheral wall of the chamber.

The base 204 also includes, in this example, four material outlets 36 through which non-solidified build material can pass to reach the collector 30 and outlet channel 24. Other examples may have one material outlet or any other number of material outlets arranged in any suitable pattern.

The upper surface 34 of the base 204 also includes, in this example, a pattern of trenches 38 to assist in the distribution of fluidisation medium across the bottom of a build cake supported on the base. Other examples may have no such trenches.

The material outlets 36 of this example each include a perforated cover 40 to hinder the flow of non-solidified build material through the material outlets 36. In other examples material outlets may not include a cover.

In use during a fluidisation phase, a fluidisation medium is forced out of the distributor within the base 204 through the plurality of outlets 218 to fluidise non-solidified build material in a build cake which rests upon the base 204. During a non-solidified build material removal phase non-solidified build material is allowed to pass though the material outlets 36 into the collector 30 which funnels the build material to the build material removal channel 24.

FIG. 5 shows a schematic view of an example of a decake system 42 which comprises the example of a decake apparatus 301 similar to that shown in FIG. 2, except that this example includes a fluidisation controller 44 which controls the flow of, the fluidisation medium 22 being forced into the distributer. The fluidisation controller 44 comprises a heater 96 to heat the fluidisation medium 22 being forced into the distributer. In other examples the fluidisation controller 44 comprises a chiller to cool the fluidisation medium 22 being forced into the distributer.

The system 42 includes a controller 46 to control components of the system 42 as set out below. The build material removal channel 24 is coupled to an outlet valve 48 which, when closed, prevents non-solidified build material from passing into a suction system 50. When open the outlet valve 48 permits build material to fall, or be drawn, into the suction system 50. In this example non-solidified build material initially fills the volume between the material outlets 36 and the outlet valve 48 which prevents non-solidified build material passing through the material outlets 36.

The suction system 50 comprises a suction pump 52 and build material trap 62 coupled to the outlet valve 48 through a CT′ coupling 54, although other examples may use other couplings. Also coupled to the coupling 54 is a secondary inlet 56 which includes a filter 58, and between the filter 58 and the coupling 54 is an inlet valve 60. The inlet valve 60, when closed, restricts the suction pump 52 to drawing air into the suction system though the build material removal channel 24 of the decake apparatus 301. When open, the inlet valve 60, permits the suction pump to also draw air through the filter 58 and secondary inlet 56 which may help to transport build material to the build material trap 62.

The controller 46 controls the fluidisation controller 44, the outlet valve 48, the inlet valve 60 and the suction pump 52. In other examples some of these may be controlled manually, or by a different controller.

The fluidisation controller 44 controls the temperature of the fluidisation medium, in this case air, to control the cooling of a build object within the build cake.

The fluidisation medium may be heated by the heater 96 so that it substantially matches the temperature of the build object so that the build object is not significantly cooled by the movement of fluidisation medium. In other examples the fluidisation controller controls the temperature of the fluidisation medium to accelerate the cooling of the build object in a controlled manner by reducing the fluidisation medium temperature during the fluidisation process.

The fluidisation controller 44 controls the flow rate of the fluidisation medium into the build cake. This controls the fluidisation of the non-solidified build material. During fluidisation the flow rate is sufficient for incipient fluidisation of the non-fluidised build material to be achieved. Higher flow rates may reduce the density of the fluidised non-solidified build material which may accelerate the sinking of the build object. High flow rates may also lead to bubbles being formed within the bed which may adversely affect the control of the sinking of the build objects.

The system 42 also includes a material sensor 98 coupled to the controller 46. In this example the material sensor 98 is a part of the decake apparatus 301. The controller 46 receives a signal from the material sensor 98 indicative of the presence, or absence, of a threshold quantity non-solidified build material within the chamber. The material sensor 98 may be any suitable sensor, for example a camera, ultrasonic sensor, laser sensor, weight sensor or contact sensor.

This signal from the material sensor 98 can be used to determine when sufficient non-solidified build material has been removed to allow a user to recover the build objects and provide an indication to a user. The signal from the material sensor 98 can also be used by the controller 46 to determine whether the flow of fluidisation medium should be stopped and/or whether removal of non-solidified build material can be stopped. In other examples a material sensor is part of the system 42 and can be coupled to the decake apparatus 301.

In use, with a build cake located on the base, the controller 46 controls the fluidisation controller 44 to control the flow and temperature of fluidisation medium to fluidise the non-solidified build material and cause build objects in the build cake to sink in a controlled manner towards the base 304. The controller 46 receives a signal from the contact sensor 31 to indicate when the build objects are in contact with the base 304. The controller 46 then controls the outlet valve 48 to open and allow non-solidified build material to pass into the suction system 50. The opening of the outlet valve also allows non-solidified build material to pass through the material outlets and so removes non-solidified build material from the chamber. The controller 46 also controls the suction pump 52 to begin drawing air though the material outlets 36 and controls the actuation of the inlet valve 60 to assist with transporting material to the build material trap 62.

In other examples the controller may fewer components that set out above, and/or may control additional components, such as valves or other movable obstructions in the material outlets, or a vibration system to assist with fluidisation or the flow of material through the material outlets. The controller may comprise a plurality of sub-controllers. Some of the components noted above may be manually controlled.

FIG. 6 shows a flow chart of an example method 64 in which a build cake is supported 66 in a chamber on a base. The build cake comprises a build object and non-solidified build material.

A fluidisation medium is then forced 68 from a distributor into a lower portion of the build cake to fluidise non-solidified build material around the build object. The build object is allowed to sink 70 through the fluidised non-solidified build material towards the base.

FIG. 7 shows a flow chart of a different example method 72 in which a build cake is supported 74 in a chamber on a base. The build cake comprises a build object and non-solidified build material.

A fluidisation medium is then forced 76 from a distributor into a lower portion of the build cake to fluidise non-solidified build material around the build object. The build object is allowed to sink 78 through the fluidised non-solidified build material in a controlled manner towards the base. While fluidisation medium is forced 76 into the build cake, and the build object is allowed to sink 78, the fluidisation medium may be controlled 80.

The control 80 of the fluidisation medium comprises controlling the temperature of the fluidisation medium to accelerate cooling of the build object without speeding to cooling to a degree that might damage the build object. This is achieved by initially heating the fluidisation medium to a temperature similar to that of the build object and fluidising the non-solidified build material. During fluidisation, while the build object is sinking and/or while the build object has reached the lowest point of its travel, the temperature of the fluidisation medium is reduced at a rate faster than might be achieved through passive cooling of the build object and build cake. This may help to cool the build object and the rate of cooling of the build object can be controlled.

In some examples the control 80 of the fluidisation medium comprises controlling the flow rate of the fluidisation medium into the build cake. The flow rate of fluidisation medium through the build cake controls the fluidisation of the non-solidified build material. As noted above, the flow rate should be sufficient for incipient fluidisation to be achieved and higher flow rates may further reduce the density of the fluidised non-solidified build material which may accelerate the sinking of the build object.

Once the build object has sunk towards the base in a controlled manner non-solidified build material can be removed 82 from the build cake to reveal the build object. The removal 82 of the non-solidified build material may be through a material outlet through the base as discussed above. In other examples the removal of the non-solidified build material may comprise manual removal, using hand tools, or suction devices.

FIG. 8 shows a schematic diagram of a controller 146. The controller 146 may be suitable for use as the controller 46 in the system 42 of FIG. 5. In this example the controller 146 comprises a non-transitory computer-readable storage medium 84 comprising instructions 86 executable by a processor. The computer-readable storage medium 68 comprising:

Instructions 88 to force a fluidisation medium from a distributor into a lower portion of a build cake. The build cake is supported in a chamber on a base and comprises a build object and non-solidified build material. The fluidisation medium is forced into a lower portion of the build cake to fluidise non-solidified build material around the build object formed in the build cake.

Instructions 90 to allow the build object to sink through the fluidised non-solidified build material towards the base.

As set out above, there may be a plurality of build objects in the build cake.

In some examples the controller includes instructions 92 to open an outlet valve and draw air through an outlet opening in the base to entrain non-solidified build material from the build cake around the build object so that the non-solidified build material is removed from the build cake through the outlet opening.

In some other examples the controller includes instructions 94 to open an outlet valve and draw air through an outlet opening in the base to entrain non-solidified build material from the build cake around the build object so that the non-solidified build material is removed from the build cake through the outlet opening at the same time as forcing a fluidisation medium from a distributor into a lower portion of a build cake.

1. A decake apparatus, the decake apparatus comprising a chamber having a base to support a build cake comprising a build object and non-solidified build material, the apparatus comprising a distributor from which to force a fluidisation medium into a lower portion of a build cake supported on the base to fluidise non-solidified build material around the build object so that the build object sinks through the fluidised non-solidified build material towards the base, the apparatus further comprising a material outlet through which non-solidified build material can be removed from the chamber.

2. A decake apparatus as claimed in claim 1, in which the base comprises the distributor and the distributor comprises a plurality of outlets through which a fluidisation medium can be forced into a build cake.

3. A decake apparatus as claimed in claim 2, in which the apparatus comprises a heater to heat the fluidisation medium prior to the fluidisation medium being forced into the build cake.

4. A decake apparatus as claimed in claim 1, in which the base includes an outlet valve and material outlet through which non-solidified build material can pass when the outlet valve is open.

5. A decake apparatus as claimed in claim 1, in which the apparatus comprises controller to control the flow of fluidisation medium into a lower portion of a build cake supported on the base and to control the removal of non-solidified build material from the chamber through the material outlet.

6. An additive manufacturing process comprising:
supporting a build cake in a chamber on a base, the build cake comprising a build object and non-solidified build material;
forcing a fluidisation medium from a distributor into a lower portion of the build cake to fluidise non-solidified build material around the build object such that the build object sinks through the fluidised non-solidified build material towards the base.

7. An additive manufacturing process as claimed in claim 6, in which the base includes the distributor and fluidisation medium is forced into the build cake through a plurality of outlets from the distributor.

8. An additive manufacturing process as claimed in claim 7, in which the process comprises forcing a fluidisation medium from the distributor into the build cake to fluidise non-solidified build material around the build object until the build object sinks through the fluidised non-solidified build material and into contact with the base.

9. An additive manufacturing process as claims in claim 6, in which the fluidisation medium is heated prior to being used to fluidise non-solidified build material of the build cake.

10. An additive manufacturing process as claimed in claim 7, in which the process comprises opening an outlet valve thereby allowing non-solidified build material to pass through a material outlet in the base.

11. An additive manufacturing process as claimed in claim 10, in which the process comprises drawing air through the material outlet and entraining non-solidified build material in that airflow.

12. An additive manufacturing process as claimed in claim 10, in which the air is drawn through the material outlet in the base while a fluidisation medium is forced into a lower portion of the build cake to fluidise non-solidified build material.

13. A non-transitory machine-readable storage medium comprising instructions executable by a processor, the machine-readable storage medium comprising instructions to:
force a fluidisation medium from a distributor into a lower portion of a build cake supported on a base to fluidise non-solidified build material around a build object within the build cake such that the build object sinks through the fluidised non-solidified build material towards the base.

14. A non-transitory machine-readable storage medium as claimed in claim 13, in which the instructions comprise instructions to:
open an outlet valve and draw air through a material outlet in the base to entrain non-solidified build material from the build cake around the build object so that the non-solidified build material is removed from the build cake through the material outlet.

15. A non-transitory machine-readable storage medium as claimed in claim 14, in which the instructions comprise instructions to:
force a fluidisation medium from a distributor into a lower portion of a build cake at the same time as drawing air through a material outlet in the base.
